(19) United States
(12) Patent Application Publication
(10) Pub. No.: US 2016/0043640 A1
(43) Pub. Date: Feb. 11, 2016

(54) SWITCH MODE POWER SUPPLY WITH A CASCODE CIRCUIT

(71) Applicants: PHOENIX CONTACT GMBH & CO KG, Blomberg (DE); Phoenix Contact Power Supplies GmbH, Paderborn (DE)

(72) Inventors: Hartmut HENKEL, Blomberg (DE); Michael HEINEMANN, Lage (DE); Guido REMMERT, Hamm (DE)

(21) Appl. No.: 14/652,732

(22) PCT Filed: Nov. 18, 2013
(86) PCT No.: PCT/EP2013/074095

§ 371 Date: Jun. 16, 2015

(30) Foreign Application Priority Data
Dec. 17, 2012 (DE) 10 2012 112 391.8

(51) Int. Cl. H02M 3/158

(52) U.S. Cl. CPC H02M 3/158

(57) ABSTRACT

The invention relates to a switch mode power supply (202) including a switch element (308) having an NPN-bipolar transistor (402) and a self-conductive field effect transistor (404). The NPN-bipolar transistor (402) and the field effect transistor (404) are connected to form a cascode (400). The NPN-bipolar transistor (402) is electrically connected to a winding (502) of a transformer (504), and an additional winding (508) of the transformer (504) is electrically connected to a base connection (408) of the bipolar transistor (402).

The present invention relates to a switch mode power supply.

Switch mode power supplies have a switching element with which a rectified and possibly smoothed electrical voltage is chopped before this chopped electrical voltage is transformed and again rectified and also possibly additionally smoothed.

As switching elements for electrical voltages in the range of 100-1000 VDC, individual switches or a plurality of switches which are connected in parallel are used as high-voltage switches. All kinds of MOSFETs, IGBTs and bipolar transistors can be used in this case. However, the modern high-voltage MOSFETs have greatly increased switching losses and line losses when operated at switching frequencies in the range of from 20 kHz to 200 kHz as the frequency increases.

The object of the present invention is therefore to provide a switch mode power supply with less switching losses.

This object is achieved by the subject matter having the features as claimed in the independent claim. Advantageous embodiments are the subject matter of the dependent claims, the description and the figures.

The present invention is based on the knowledge that the switching losses can be minimized, without appreciably increasing the conductive losses, by combining different types of transistor.

According to a first aspect, the object is achieved by a switch mode power supply comprising a switching element, wherein the switching element has a bipolar transistor and a field-effect transistor, wherein the bipolar transistor and the field-effect transistor are connected to form a cascode. Thus, the technical advantage is achieved that the advantages of a field-effect transistor, specifically to switch quickly, and the advantages of a bipolar transistor, specifically to have high reverse voltages, are combined. The switching losses are minimized in this way.

In one advantageous embodiment, the bipolar transistor is an npn transistor. Thus, the technical advantage is achieved that an electronic component which is available in large numbers and with a high quality can be used.

In one advantageous embodiment, the field-effect transistor is a self-conducting field-effect transistor. Thus also, the technical advantage is achieved that an electronic component which is available in large numbers and with a high quality can be used.

In one advantageous embodiment, an emitter connection of the bipolar transistor is electrically conductively connected to a drain connection of the field-effect transistor. Thus, the technical advantage is achieved that the field-effect transistor and the bipolar transistor are connected in series. A cascode with an only slightly increased electrical internal resistance is provided in this way since the electrical internal resistance of the field-effect transistor (Rdson) is very low. It is, for example, less than 1 mΩ.

In one advantageous embodiment, the cascade, when being in a conducting state, is in a self-holding. Thus, the technical advantage is achieved that only a brief alternating signal, which is provided by a control system, is required in order to cause a change of the cascode from the non-conducting state to the conducting state.

In one advantageous embodiment, for the purpose of self-holding, an emitter connection of the bipolar transistor is electrically conductively connected to a winding of an auxiliary transformer, and wherein a further winding of the auxiliary transformer is electrically conductively connected to a base connection of the bipolar transistor.

Thus, the technical advantage is achieved that an electrical voltage for driving the bipolar transistor can be obtained with the auxiliary transformer. Therefore, a separate energy source which provides an electrical voltage of this kind is not required.

In one advantageous embodiment, a converter unit is electrically conductively looped between the further winding and the base connection. Thus, the technical advantage is achieved that an electrical voltage which is matched to the bipolar transistor and is possibly smoothed and/or buffered is provided. Particularly reliable operation of the switch mode power supply is possible in this way.

In one advantageous embodiment, for the purpose of self-holding, a switch mode power supply transformer is provided, said switch mode power supply transformer having a center tap which is electrically conductively connected to the converter unit. Thus, the technical advantage is achieved that only a modified transformer, but no additional transformer, is required. The design is further simplified in this way.

In one advantageous embodiment, the converter has a winding which is electrically conductively connected to the switching element, wherein the center tap is associated with the winding. Thus, the technical advantage is achieved that a converter which is modified in a particularly simple manner can be used. The design is once again simplified in this way.

In one advantageous embodiment, the switch mode power supply is primary switched. Thus, the technical advantage is achieved that the switch mode power supply can be operated at high frequencies and has compact dimensions.

In one advantageous embodiment, the switch mode power supply has an input rectifier which has a power supply connection for electrically conductively connecting to a power supply. Thus, the technical advantage is achieved that the switch mode power supply can be connected without problems to a power supply for supplying electrical energy, said power supply supplying electrical AC voltage.

In one advantageous embodiment, the switching element has an input which is electrically conductively connected to an output of the input rectifier. Thus, the technical advantage is achieved that the electrical voltage which is rectified by the input rectifier can be chopped by the switching element, with the result that a chopped electrical voltage is provided.

In one advantageous embodiment, the switch mode power supply has a converter which has an input which is electrically conductively connected to an output of the switching element. Thus, the technical advantage is achieved that the chopped electrical voltage can be raised or lowered to another voltage level.

In one advantageous embodiment, the switch mode power supply has an output rectifier which has an input which is electrically conductively connected to an output of the converter. Thus, the technical advantage is achieved that a rectified electrical voltage can be provided by the switch mode power supply.

According to a second aspect, the object is achieved by an electrical assembly having a switch mode power supply of this kind. Thus, the technical advantage is achieved that the advantages of a field-effect transistor, specifically to switch quickly, and the advantages of a bipolar transistor, specifically to have high reverse voltages, are combined. The switching losses are minimized in this way.

According to a third aspect, the object is achieved by the use of a cascode circuit. Thus, the technical advantage is achieved that the advantages of a field-effect transistor, specifically to switch quickly, and the advantages of a bipolar transistor, specifically to have high reverse voltages, are combined. The switching losses are minimized in this way.

According to a fourth aspect, the object is achieved by a method for driving a cascode circuit. Thus, the technical advantage is achieved that the advantages of a field-effect transistor, specifically to switch quickly, and the advantages of a bipolar transistor, specifically to have high reverse voltages, are combined. The switching losses are minimized in this way.

Further exemplary embodiments will be explained with reference to the appended figures, in which:

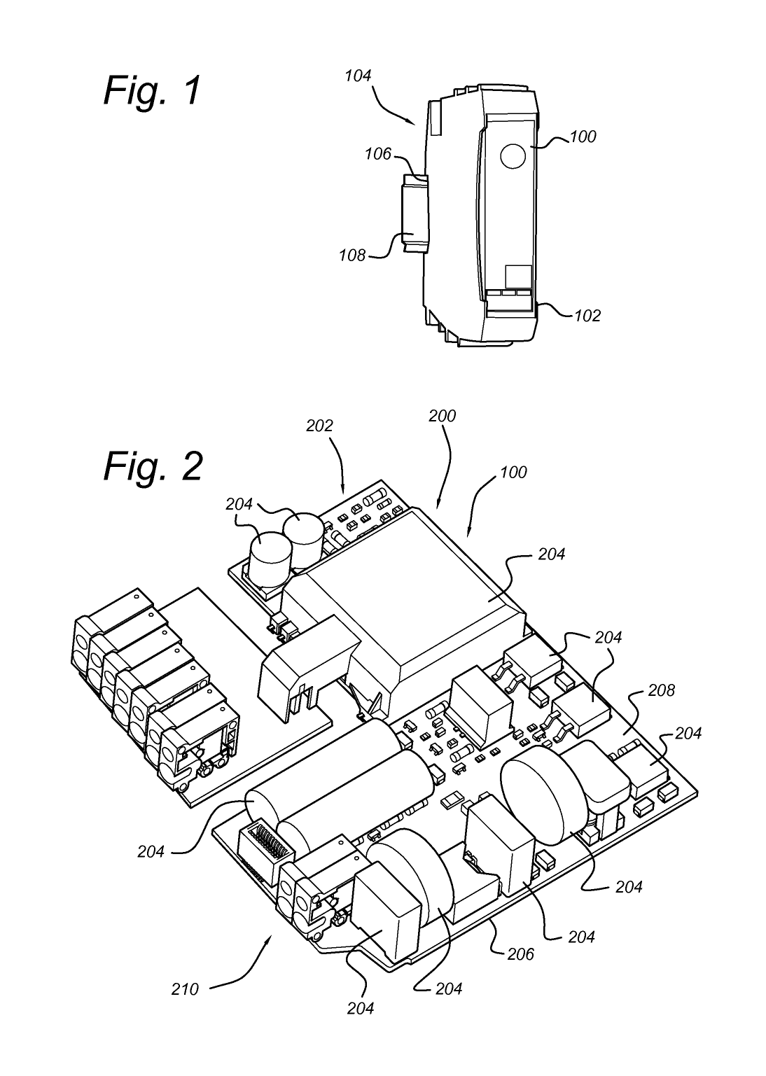

FIG. 1 shows a perspective view of an electrical assembly;

FIG. 2 shows a perspective view of a carrier having a power supply component;

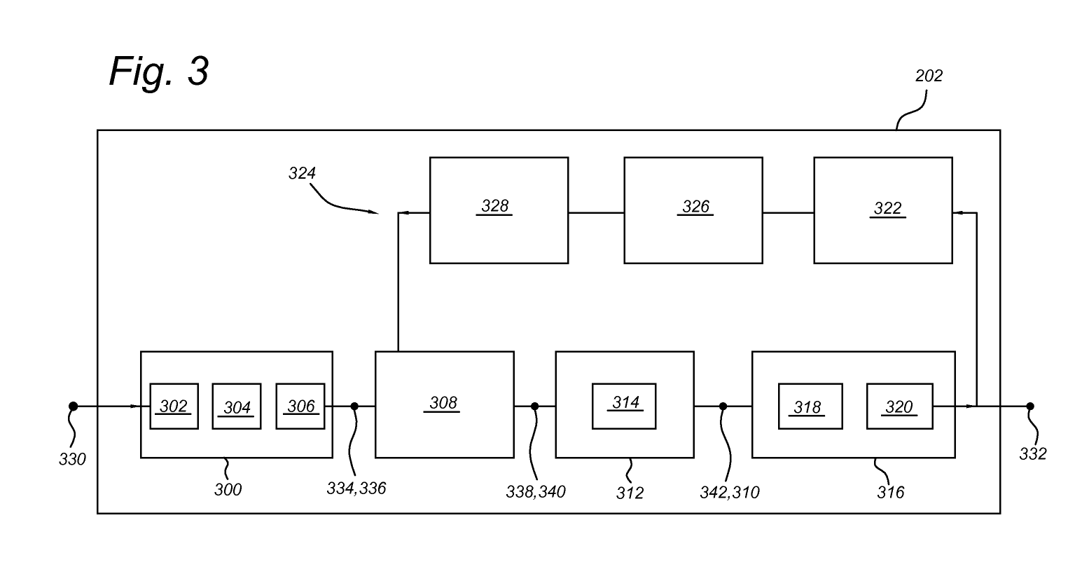

FIG. 3 shows a schematic illustration of a switch mode power supply;

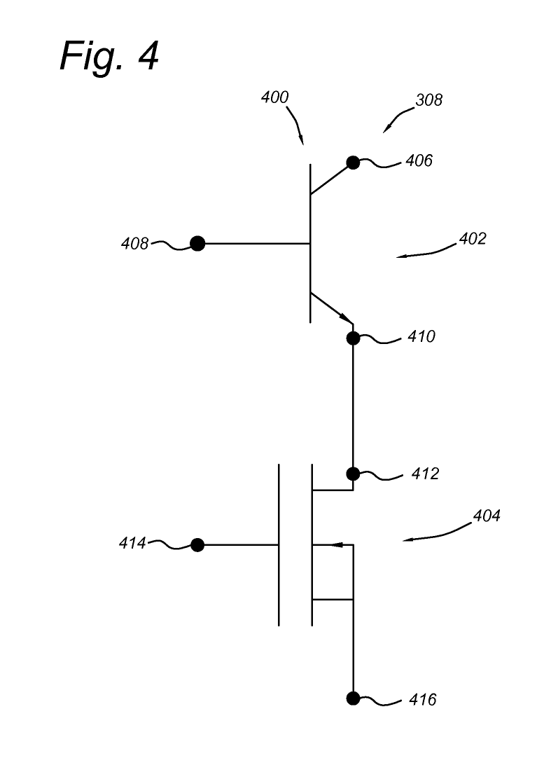

FIG. 4 shows a circuit diagram of a cascode of the switch mode power supply from FIG. 3;

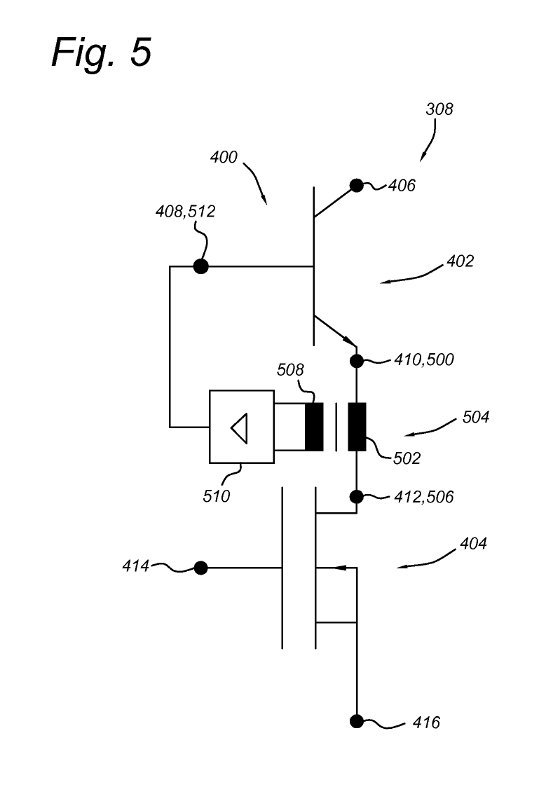

FIG. 5 shows a further circuit diagram of a cascode; and

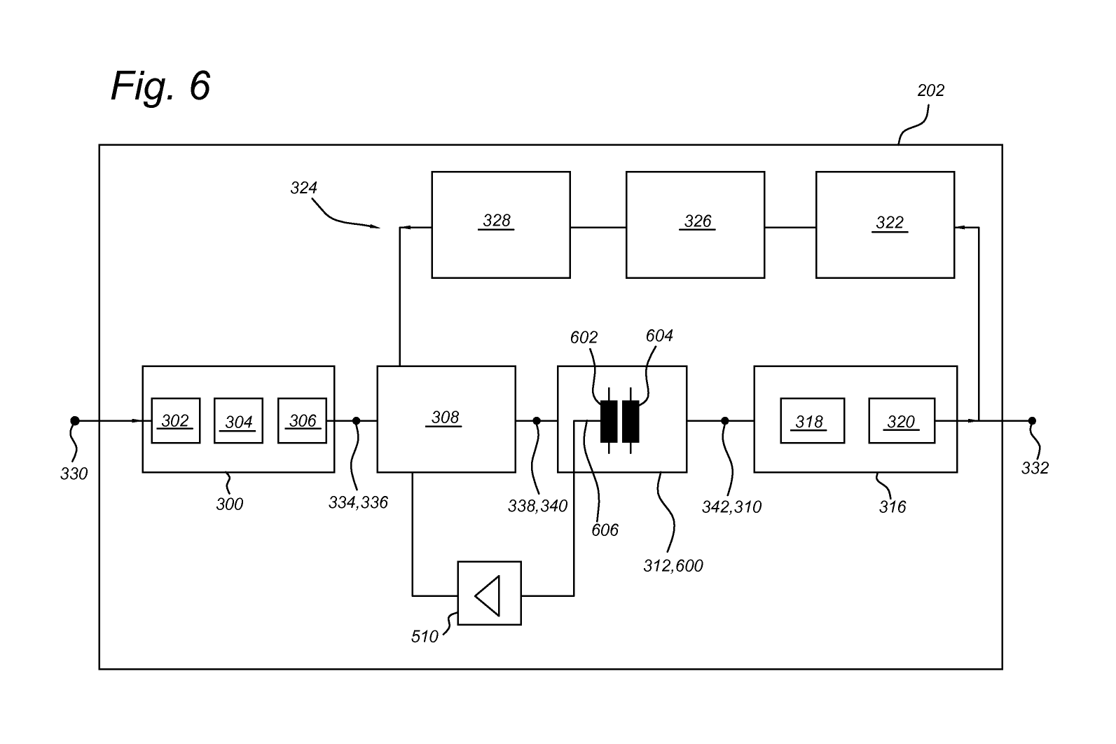

FIG. 6 shows a further schematic illustration of a switch mode power supply.

FIG. 1 shows a switch mode power supply as an exemplary embodiment for an electrical assembly 100. The electrical assembly 100 has a housing 102 which, in the present exemplary embodiment, has a latching device 106 on its rear face 104, said housing being latched to a top-hat rail 108 by way of said latching device.

FIG. 2 shows an exemplary embodiment of a power supply component 200 of the electrical assembly 100. The power supply component 200 is in the form of a switch mode power supply 202 in the present exemplary embodiment.

In the present exemplary embodiment, the power supply component 200 comprises a plurality of electrical components 204 which are arranged on a carrier 206 and are correspondingly interconnected in the present exemplary embodiment.

FIG. 3 shows an exemplary embodiment of a schematic design of the switch mode power supply 202. The switch mode power supply 202 has a power supply connection 330 for connection to a power supply voltage, for example 230 volts, 50 Hz, and also has an output connection 332 to which an electrical load (not illustrated) can be connected.

In the present exemplary embodiment, the switch mode power supply 202 has an input rectifier 300 which rectifies and smoothes the power supply voltage. To this end, the input rectifier 300 has a power supply filter 302, a diode 304 or a bridge rectifier and a smoothing capacitor 306, such as an electrolytic capacitor for example, in the present exemplary embodiment.

The rectified and smoothed electrical voltage is then chopped. To this end, the switch mode power supply 202 has a switching element 308 in the present exemplary embodiment, said switching element having an input 334 which is electrically conductively connected to an output 336 of the input rectifier 300.

The chopped electrical voltage is then transformed by a converter 312. To this end, the converter 312 has an input 338 in the present exemplary embodiment, said input being electrically conductively connected to an output 340 of the switching element 308. Furthermore, the converter 312 has a ferrite-core transformer 314 in the present exemplary embodiment. This additionally provides galvanic isolation between the output end and input end of the switch mode power supply 202.

The transformed electrical voltage is again rectified and smoothed by an output rectifier 316. The output rectifier 316 has an input 342 which is electrically conductively connected to an output 310 of the converter 312. To this end, the output rectifier 316 has a diode 318 or a bridge rectifier and a second smoothing capacitor 320, such as an electrolytic capacitor for example, in the present exemplary embodiment.

Furthermore, the switch mode power supply 202 has a controller 322 in the present exemplary embodiment. In the present exemplary embodiment, the controller 322 uses pulse-width modulation or pulse-phase control to ensure that, apart from losses in the switch mode power supply 202 itself, only as much energy flows into the switch mode power supply device 202 as is passed on to an electrical load.

The controller 322 is arranged in a control loop 324. In the present exemplary embodiment, the control loop 324 connects the output end and the input end of the switch mode power supply 202. An optocoupler 326 is provided in the present exemplary embodiment in order to galvanically isolate the control loop 324 from the power supply.

Finally, the switch mode power supply 202 has a control system 328 which drives the switching element 308 in order to move the switching element 308 from a conducting state to a non-conducting state, and vice versa.

In the present exemplary embodiment, the switching element 308 is located in the primary circuit of the ferrite-core transformer 314, and therefore the switch mode power supply 202 is a primary switched switch mode power supply in the present exemplary embodiment. As an alternative, the switching element 308 can be arranged in the secondary circuit of the ferrite-core transformer 314, and therefore said switch mode power supply is a secondary switched switch mode power supply.

FIG. 4 shows the switching element 308 which has a cascode 400 in the present exemplary embodiment.

In the present exemplary embodiment, the cascode 400 has a bipolar transistor 402 and a field-effect transistor 404 which are connected in series. The bipolar transistor 402 has a collector connection 406, a base connection 408 and an emitter connection 410. The field-effect transistor 404 has a drain connection 412, a gate connection 414 and a source connection 416. In the present exemplary embodiment, the bipolar transistor 402 is an npn transistor. Furthermore, the bipolar transistor 402 has an electrical reverse voltage of 400 to 1000 VDC in the present exemplary embodiment. In the present exemplary embodiment, the field-effect transistor 404 is an n-type field-effect transistor, for example a MOSFET. In the present exemplary embodiment, the field-effect transistor 404 has an electrical reverse voltage of 10 to 30 VDC. In addition, the field-effect transistor 404 is of the self-conducting type in the present exemplary embodiment.

In order to interconnect the bipolar transistor 402 and the field-effect transistor 404 in series, the emitter connection 410 of the bipolar transistor 402 and the drain connection 412 of the field-effect transistor 404 are directly electrically conductively connected to one another in the present exemplary embodiment.

Furthermore, the collector connection 406 is electrically conductively connected to the output 336 of the first rectifier 300, and the source connection 416 is electrically conductively connected to an input 342 of the ferrite-core transformer 314 of the converter 312.

In addition, the base connection 408 of the bipolar transistor 402 and the gate connection 414 of the field-effect transistor 404 are electrically conductively connected to the control system 328 in the present exemplary embodiment.

During operation, the bipolar transistor 402 is driven by the control system 328 such that it is in a conducting state. Therefore, the cascode 400 is self-conducting since the field-effect transistor 404 is of the self-conducting type. In order to move the cascode 400 to a non-conducting state, the control system 328 drives the field-effect transistor 404 such that the electrical drain voltage and therefore the emitter voltage of the bipolar transistor 402 increase to a value which is above the electrical voltage (with respect to ground) which is applied to the base connection 408. As a result of this, the base of the bipolar transistor 402 is depleted of charge carriers, and therefore the bipolar transistor 402 changes to the non-conducting state and adopts the high reverse voltage.

FIG. 5 shows a further exemplary embodiment of a cascode 400.

The cascode 400 shown in FIG. 5 has the same design as the cascode 400 shown in FIG. 4, apart from the difference that the emitter connection 410 of the bipolar transistor 402 is electrically conductively connected to an input 500 of a winding 502 of an auxiliary transformer 504. Furthermore, the drain connection 412 is electrically conductively connected to an output 506 of the winding 502 of the auxiliary transformer 504. In the present exemplary embodiment, the auxiliary transformer 504 has a second winding 508 which is magnetically coupled to the first winding 502. The second winding 508 is electrically conductively connected to a converter unit 510 which converts and possibly smoothes the electrical voltage induced in the second coil 508. The converter unit 510 has an output 512 which is electrically conductively connected to the base connection 408 of the bipolar transistor 402.

During operation, when the cascode 400 is in the conducting state, an electric current flows through the first winding 502 of the transformer, and therefore an electrical voltage is induced in the second winding 508 of the transformer 504, said electrical voltage being converted by the converter unit 510 and being fed to the base connection 408 of the bipolar transistor 402 and, as drive signal, having the effect that the bipolar transistor 402 remains in the conducting state. Therefore, the cascode 400 is operated in a self-holding state. Therefore, only a brief change signal, which is provided by the control system 328, is required in order to move the cascode 400 from the non-conducting state to the conducting state since the cascode 400 remains in the conducting state on account of the self-holding. Otherwise, the manner of operation of this exemplary embodiment corresponds to that of the exemplary embodiment shown in FIG. 4.

FIG. 6 shows a further exemplary embodiment of the switch mode power supply 202.

The switch mode power supply 202 shown in FIG. 5 has the same design as the switch mode power supply 202 shown in FIG. 3 apart from the difference that the converter 312 has a switch mode power supply transformer 600 with a first winding 602 and with a second winding 604, wherein, in the present exemplary embodiment, the first winding 602 has an additional center tap 606 which is electrically conductively connected to the converter unit 510, the output 512 of said converter unit again being electrically conductively connected. Therefore, in contrast to the above exemplary embodiment shown in FIG. 5, this exemplary embodiment does not have an auxiliary transformer 504.

During operation, when the cascode 400 is in the conducting state, an electric current flows through the first winding 602 of the transformer, and therefore an electrical voltage is induced in the second winding 604 of the switch mode power supply transformer 600, said electrical voltage being converted by the converter unit 510 and being fed to the base connection 408 of the bipolar transistor 402 and, as drive signal, having the effect that the bipolar transistor 402 remains in the conducting state. Therefore, the cascode 400 is operated with self-holding here too. Otherwise, the manner of operation of this exemplary embodiment corresponds to that of the exemplary embodiment shown in FIG. 4.

### LIST OF REFERENCE SYMBOLS

100 Electrical assembly

102 Housing

104 Rear face

106 Latching device

108 Top-hat rail

200 Power supply component

202 Switch mode power supply

204 Electrical component

206 Multilayer carrier

300 Input rectifier

302 Power supply filter

304 Diode

306 Smoothing capacitor

308 Switching element

310 Output

312 Converter

314 Ferrite-core transformer

316 Output rectifier

318 Diode

320 Smoothing capacitor

322 Controller

324 Control loop

326 Optocoupler

328 Control system

330 Power supply connection

332 Output connection

334 Input

336 Output

338 Input

340 Output

342 Input

400 Cascode

402 Bipolar transistor

404 Field-effect transistor

406 Collector connection

408 Base connection

410 Emitter connection

412 Drain connection

414 Gate connection

416 Source connection

500 Input

502 Winding

504 Auxiliary transformer

506 Output

508 Winding

510 Converter unit

512 Output

600 Switch mode power supply transformer

602 Winding

604 Winding

606 Center tap

1. A switch mode power supply, comprising
a switching element, wherein
the switching element has a bipolar transistor and a field-effect transistor, wherein the bipolar transistor and the field-effect transistor are connected to form a cascode.

2. The switch mode power supply of claim 1, wherein the bipolar transistor is an npn transistor.

3. The switch mode power supply of claim 1, wherein the field-effect transistor is a self-conducting field-effect transistor.

4. The switch mode power supply of claim 1, wherein an emitter connection of the bipolar transistor is electrically conductively connected to a drain connection of the field-effect transistor.

5. The switch mode power supply of claim 1, wherein the cascode, when being in a conducting state, is in a self-holding state.

6. The switch mode power supply claim 5, wherein, the self-holding state is achieved by electrically conductively connecting an emitter connection of the bipolar transistor to a winding of an auxiliary transformer, and by electrically conductively connecting a further winding of the auxiliary transformer to a base connection of the bipolar transistor.

7. The switch mode power supply of claim 6, wherein the further winding and the base connection include a converter unit that is electrically conductively looped there between.

8. The switch mode power supply of claim 5, wherein, the self-holding state is achieved by providing a switch mode power supply transformer is provided, said switch mode power supply transformer having a center tap that is electrically conductively connected to the converter unit.

9. The switch mode power supply of claim 8, wherein the switch mode power supply transformer includes a winding which is electrically conductively connected to the switching element, and wherein the center tap is associated with the winding.

10. The switch mode power supply of claim 1, wherein the switch mode power supply is primary switched.

11. The switch mode power supply of claim 1, wherein the switch mode power supply has includes an input rectifier which includes a power supply connection for electrically conductively connecting to a power supply.

12. The switch mode power supply of claim 11, wherein the input rectifier includes an output that is electrically conductively connected to an input of the switching element.

13. The switch mode power supply of claim 12, further comprises a converter which includes an input that is electrically conductively connected to an output of the switching element.

14. The switch mode power supply as claimed in claim 13, wherein the converter includes an output that is electrically conductively connected to an input of an output rectifier.

15. An electrical assembly, having the switch mode power supply of claim 1.
